(19) United States
(12) Patent Application Publication
(10) Pub. No.: US 2004/0097605 A1
(43) Pub. Date: May 20, 2004

(54) Cellular rubber material and producion process therefor

(76) Inventors: Kenji Kurisu, Hiroshima-ken (JP); Ichiro Sagae, Kawasaki-shi (JP); Masashi Tsukamoto, Kawasaki-shi (JP)

Correspondence Address: FLYNN THIEL BOUTELL & TANIS, P.C., 2026 RAMBLING ROAD, KALAMAZOO, MI, 49008-1699, US

(21) Appl. No.: 10/679,526

(22) Filed: Oct. 6, 2003

Related U.S. Application Data
(60) Provisional application No. 60/436,469, filed on Dec. 27, 2002.

(30) Foreign Application Priority Data
Nov. 18, 2002 (JP) 2002-333480

(51) Int. Cl. C08J 9/00; C08K 3/00

(52) U.S. Cl. 521/50.5; 521/96

(57) ABSTRACT

There is provided a cellular rubber material useful for industrial materials, building components or car parts; such as powder puff, sound insulator, heat insulator, cushioning material, gasketing material, sealing material, packing material, container, packaging material and floor covering material. A cellular rubber material is prepared by extrusion-molding into a predetermined shape, heating, crosslinking and foaming a rubber composition comprising (A) 100 parts by mass of polymer which contains 30 to 100% by mass of polar group-substituted polymer, (B) 1 to 30 parts by mass of organic blowing agent, and (C) 0.1 to 10 parts by mass of organic peroxide.

### CROSS REFERENCE TO RELATED APPLICATIONS

This application is an application filed under 35 U.S.C. §111(a) claiming benefit pursuant to 35 U.S.C. §119(e)(1) of the filing date of Provisional Application 60/436,469 filed Dec. 27, 2002 pursuant to 35 U.S.C. §111(b)

### FIELD OF THE INVENTION

This invention relates to a cellular rubber material of high shock absorbing properties, elasticity, chemical resistance, flame resistance, weathering resistance and permanent compression strain. More particularly, this invention relates to a cellular rubber material prepared by continuous extrusion-crosslink-foaming which is useful for industrial materials, building components or car parts; such as powder puff, sound insulator, heat insulator, cushioning material, gasketing material, sealing material, packing material, container, packaging material and floor covering material.

### BACKGROUND OF THE INVENTION

Cellular rubber materials, which are also formed rubber materials, are now used in various fields such as cushioning material, thermal insulator and sealing material. In general, there are used acrylonitrile-butadiene rubber (NBR), ethylene-propylene-diene terpolymer rubber (EPDM), silicone rubber, natural rubber and the like as a cellular rubber material, while they have drawbacks either in staining properties, skin irritant action, weathering properties, flame resistance or chemical resistance.

In known methods for preparing a highly foamed cellular rubber material, a kneaded mixture of rubber, blowing agent, crosslinking agent, etc. is charged in a mold and heated under pressure followed by depressurizing; or rubber latex is mechanically stirred with a crosslinking agent to foam, which is then cast into a mold and heated. A drawback of these conventional methods is lower productivity due to batch production system thereof.

On the other hand, there is also known a continuous production of cellular rubber in which a rubber composition is mixed with a blowing agent and crosslinking agent, followed by extrusion thereof from an excluder, which is immediately subjected to a thermal treatment through microwave irradiation, air heating or contact with thermal medium. According to this method, it is difficult to yield highly foamed rubber of 0.2 g/cm³ or less in density and cellular homogeneity in spite of higher productivity thereof.

In order to improve the above mentioned drawback, it has been proposed cellular rubber in which chlorinated polyethylene is used. For instance, a mixture of chlorinated polyethylene and blowing agent is subjected to a crosslinking treatment through electronic irradiation and then heated above the decomposition temperature of blowing agent to yield a cellular material (see, e.g., JP-A S53-21,265 and JP-A S57-2,342). This method is advantageous to easily control foaming and to yield a highly cellular material in comparison, but is inferior in plant economy because of electronic irradiation of high energy and, in addition, the productivity is low.

Further, there has been proposed a cellular material as a powder puff prepared from a composition comprising chlorinated polyethylene, stabilizing agent, blowing agent and organic peroxide (see, e.g. JP-A H6-7220). This is no better than in-mold foaming and does not describe a method for continuously prepare a cellular material.

Furthermore, a cellular material has been yielded from a composition comprising specific chlorinated polyethylene, stabilizing agent, crosslinking agent and blowing agent by heating at normal pressures, properties thereof being unidentified except flexibility and flame resistance (see, e.g., JP-B S59-10741).

As a powder puff, a latex puff is prepared by mechanically foaming a rubber latex compound followed by curing, which is limited to an open-cellular material and inconveniently requires a number of cylindrical molds corresponding to various products.

A closed-cell sponge puff is known, which is prepared a cellular material from solid rubber added with a blowing agent and others by charging in a mold and heating under pressure. The problems are a considerable loss of material caused by stamping a rubber sheet taken out of the mold to a shape similar to product, and lower productivity due to batch production.

A urethane sponge puff is formed as a cellular material by extruding a solvent-containing urethane resin composition followed by vaporizing the solvent at reduced pressures, which undesirably causes a considerable loss of material and solvent recovery as an additional load.

Although composite products with latex puff, closed-cell sponge puff, urethane sponge puff and the like have been known, they also have problems such as difficulty in composite molding and an excessive number of steps including post handling.

### SUMMARY OF THE INVENTION

Accordingly, it is an object of this invention to provide a cellular rubber material useful for industrial materials, building components or car parts; such as powder puff, sound insulator, heat insulator, cushioning material, gasketing material, sealing material, packing material, container, packaging material and floor covering material. Furthermore, an object of this invention is to provide a method for preparing an economically advantageous cellular rubber material.

As a result of inventors' eager investigation, it has been found that the above mentioned objects can be achieved by extruding and foaming a combination of specific polymer, organic peroxide and organic blowing agent, which has brought this invention to completion. Namely, this invention relates to a cellular rubber material and production process therefor as will be described below.

[1] A cellular rubber material prepared by heating a rubber composition comprising (A) 100 parts by mass of polymer which contains 30 to 100% by mass of polar group-substituted polymer, (B) 1 to 30 parts by mass of organic blowing agent, and (C) 0.1 to 10 parts by mass of organic peroxide.

[2] A cellular rubber material as described in [1] in which the polar group-substituted polymer contained in the polymer (A) is chlorinated polyethylene.

[3] A cellular rubber material as described in [2] in which a chlorine content of the chlorinated polyethylene is 10 to 35% by mass and Mooney viscosity at 100° C. ML₍₁₊₄₎ thereof is 30 to 100.

[4] A cellular rubber material as described in [1] in which decomposition temperature T₁ of the organic blowing agent (B) is 100 to 170° C.

[5] A cellular rubber material as described in [1] in which one-minute-half life temperature T₂ of the organic peroxide (C) is 100 to 170° C.

[6] A cellular rubber material as described in [4] or [5] in which a relationship between the decomposition temperature T₁ of organic blowing agent (B) and the one-minute-half life temperature T₂ of organic peroxide (C) is −20° C.≦(T₁−T₂)≦+30° C.

[7] A cellular rubber material prepared by extrusion-molding into a predetermined shape, heating, crosslinking and foaming a rubber composition comprising (A) 100 parts by mass of polymer which contains 30 to 100% by mass of polar group-substituted polymer, (B) 1 to 30 parts by mass of organic blowing agent, and (C) 0.1 to 10 parts by mass of organic peroxide.

[8] A cellular rubber material as described in [7] in which the polar group-substituted polymer contained in the polymer (A) is chlorinated polyethylene.

[9] A cellular rubber material as described in [8] in which a chlorine content of the chlorinated polyethylene is 10 to 35% by mass and Mooney viscosity at 100° C. ML₍₁₊₄₎ thereof is 30 to 100.

[10] A cellular rubber material as described in [7] in which decomposition temperature T₁ of the organic blowing agent (B) is 100 to 170° C.

[11] A cellular rubber material as described in [7] in which one-minute-half life temperature T₂ of the organic peroxide (C) is 100 to 170° C.

[12] A cellular rubber material as described in [10] or [11] in which a relationship between the decomposition temperature T₁ of organic blowing agent (B) and the one-minute-half life temperature T₂ of organic peroxide (C) is −20° C.≦(T₁−T₂)≦+30° C.

[13] A cellular rubber material as described in [1] or [7] in which heating is conducted by means of microwave irradiation.

[14] A method for preparing a cellular rubber material prepared by extrusion-molding into a predetermined shape, heating, crosslinking and foaming a rubber composition comprising (A) 100 parts by mass of polymer which contains 30 to 100% by mass of polar group-substituted polymer, (B) 1 to 30 parts by mass of organic blowing agent, and (C) 0.1 to 10 parts by mass of organic peroxide.

[15] A method for preparing a cellular rubber material as described in [14] in which heating is conducted by means of microwave irradiation.

### BRIEF DESCRIPTION OF THE DRAWINGS

FIG. 1 is a side view of unit for preparing cellular rubber material of this invention.

FIG. 2 is an example of extruded material shown in FIG. 1, in which (a) is a front view and (b) is side view.

FIG. 3 is another example of extruded material shown in FIG. 1, in which (a) is a front view and (b) is a side view.

FIG. 4 is still another example of extruded material shown in FIG. 1, in which (a) is a plan view and (b) is a front view.

### PREFERRED EMBODIMENTS OF TIHE INVENTION

A polymer (A) used in this invention comprises a polar group-substituted polymer in an amount of 30 to 100% by mass, preferably 50 to 100% by mass of the polymer (A). Neither sufficient microwave heating nor homogeneous and adequate foaming and crosslinking is hardly done when the polar group-substituted polymer is less than 30% by mass. A polymer to be added is not limited to a specific one, although the polar group substituted-polymer may be used alone.

The polar group-substituted polymer means those polymers having a polar group in a molecule. The polar group is a functional group having, for instance, halogen atom, oxygen atom, nitrogen atom or sulfur atom and includes chloro group, cyano group, amino group, carbolxyl group, amido group, acetyl group, ester group, sulfonic group, mercapto group, chlorosulfonic group and the like. The polar group-substituted polymer includes, for example, chlorinated polyethylene, chloroprene lubber, chlorosulfonated rubber, polyvinyl chloride, nitrile rubber, acrylonitrilebutadiene-styrene copolymer rubber, acrylic rubber, ethylene-vinyl acetate copolymer, ethylene-acrylic acid copolymer, ethylene-acrylic acid ester copolymer, ethylene-methacrylic acid ester copolymer, fluororubber, silicone rubber and the like. There may be used a blend of not less than two kinds of these polar group-substituted polymers. Chlorinated polyethylene (hereinafter referred to as CPE) is preferably used above all because of its characteristic flexibility, flame resistance, chemical resistance, weathering resistance, etc.

Polyethylene, i.e., low density polyethylene, low density polyethylene of linear chain or high density polyethylene, may be chlorinated to use as the above mentioned chlorinated polyethylene. There may be used either one of known chlorinating methods such as aqueous suspension chlorination, solution chlorination and vapor phase chlorination, although the aqueous suspension method is preferable.

Composition of chlorinated polyethylene used in this invention is not especially restricted but a preferable chlorine content thereof is 10 to 35% by mass. When the chlorine content is less than 10% by mass, the elasticity might be spoiled, while microwave heating would proceed insufficiently and homogeneous or adequate foaming and crosslinking would not be obtained. On the other hand, the chlorine content above 35% by mass might cause heterogeneous or inadequate foaming and crosslinking as well as a decrease in quality such as poor low-temperature properties.

Mooney viscosity ML₍₁₊₄₎ at 100° C. of the chlorinated polyethylene is preferably 30 to 100. Mooney viscosity ML₍₁₊₄₎ less than 30 might lower viscosity of the material and result in rough foams during the foaming process, while the viscosity above 100 might cause insufficient foaming or other inconvenience such as cracking during the foaming and crosslinking processes.

An organic blowing agent (B) used in this invention is not limited to a specific compound and may includes, for instance, azodicarbonamide, 4,4′-oxybisbenzene-sulfonyl hydrazide, dinitrosopentamethylene-tetramine, p-toluenesulfonyl hydrazide, p-toluenesulfonylacetone hydrazone, hydrazidicarbonamide and azobisisobutyronitrile. There may also be used an assistant blowing agent such as zinc, zinc compound, urea, amine compound and other basic compound for the purpose of controlling decomposition temperatures of the above mentioned organic blowing agents. These organic blowing agents may be used as a blend of two or more of them, or may be combined with an inorganic blowing agent such as sodium dicarbonate, ammonium carbonate and ammonium dicarbonate.

A content of the organic blowing agent (B) is 1 to 30 parts by mass based on 100 parts by mass of the polymer (A). The content of (B) less than 1 part by mass might result in insufficient foaming and yield a hard and less elastic product, while the content above 30 parts by mass might cause excessive foaming and undesirable cracks during molding. Further, decomposition temperature T₁ of the organic blowing agent (B) is preferably 100 to 170° C. The decomposition temperature less than 100° C. affects processing stability of the product, while a degree of homogeneous and adequate foaming is hardly obtained at the temperature above 170° C. The decomposition temperature T₁ may be expressed as an exothermal peak temperature determined by differential thermal analysis at a heat-up rate of 5° C. per minute.

An organic peroxide (C) used in this invention is not limited to a specific compound and includes, for instance, stearoyl peroxide, lauroyl peroxide, benzoyl peroxide, 4-methylbenzoyl peroxide, 1,1-bis(t-butylperoxy)-2-methylcyclohexane, 1,1-bis(t-hexylperoxy)-3,3,5-trimethylcyclohexane, 1,1-bis(t-hexylperoxy)cyclohexane, 1, 1-bis(t-butylperoxy)-3,3,5-trimethylcyclohexane, 1, 1-bis(t-butylperoxy)-3,3,5-cyclohexane, t-hexylperoxyisopropyl monocarbonate, t-butylperoxymaleic acid, t-butylperoxylaurate, t-butylperoxyisopropyl monocarbonate, t-butylperoxy-2-ethylhexyl monocarbonate, 2-ethylhexyle monocarbonate, t-hexylyperoxybenzoate, 2,5-dimethyl-2,5-di(benzoyl-peroxy)hexane, t-butylperoxybenzoate, n-butyl-4,4-bis(t-butylperoxy)valerate, di-t-butylperoxyisophthalate, a, a ′-bis(t-butylperoxy)diisopropylbenzene, dicumyl peroxide, 2,5-dimethyl-2,5-di(t-butylperoxy)hexane, t-butylcumyl peroxide and 2,5-dimethyl-2,5-di(t-butylperoxy)hexyne-3.

These organic peroxides may be used as a combination of two or more of them.

A content of the organic peroxide (C) is 0.1 to 10 parts by mass based on 100 parts by mass of the polymer (A). The organic peroxide in an amount less than 0.1 part by mass might cause insufficient crosslinking, poor elasticity and deterioration of product properties such as solid state strength, while the content above 10 parts by mass might result in excessive crosslinking, thereby forming cracks during molding. One-minute half life temperature T₂ of the organic peroxide (C) is preferably 100 to 170° C. Processing stability would be affected at the temperature below 100° C., while homogeneous and adequate foaming and crosslinking would be hardly obtained at the temperature above 170° C. The one-minute half life temperature T₂ means a temperature at which an organic peroxide is decomposed to halve a quantity of inherent active oxygen thereof within a minute. The temperature T₂ is determined by plotting half lives of the organic peroxide at plural temperatures in a solvent such as benzene which is relatively inactive to radicals.

It is preferable in this invention that a relationship between the decomposition temperature T₁ of organic blowing agent (B) and the one-minute half life temperature T₂ of organic peroxide (C) is represented as in the following:

−20° C.≦(T₁−T₂)≦+30° C.

When the relationship between T₁ and T₂ deviates from the above mentioned range, foaming-crosslinking balance might be lost to cause no foaming or cracks during molding. A more preferable relationship between the decomposition temperature T₁ of organic blowing agent (B) and the one-minute half life temperature T₂ of organic peroxide (C) is:

−10° C.≦(T₁−T₂)≦+20° C.

According to this invention, there may be added, other than (A), (B) and (C) above, various kinds of compounding additives generally used in the art, such as acid acceptor, antioxidant, antiozonant, photostabilizer, UV-absorber, processing aid, lubricant, plasticizer, tackifier, flame retardant, desiccant, pigment, carbon black, inorganic filler, coagent and accelerator.

Especially when chlorinated polyethylene is used as the polymer (A), it is preferable to add an acid acceptor. Such an acid acceptor used herein includes, for instance, oxide, hydroxide, carbonate, carboxylate, silicate, borate, phosphite, sulfite and sulfate of metals belonging to group II or group IVb of Periodic Table; and hydrotalcite group as well as epoxy compounds. More concretely, there may be used magnesium oxide, magnesium hydroxide, barium hydroxide, magnesium carbonate, barium carbonate, slaked lime, quick lime, calcium carbonate, calcium silicate, calcium stearate, barium stearate, magnesium phosphite, calcium phosphite, tin oxide, litharge, red lead, white lead, dibasic lead phthalate, dibasic lead carbonate, basic lead phosphite, dibasic lead sulfite, tribasic lead sulfate and synthetic hydrothalcite.

It is preferable to add 1 to 30 parts by mass of the oxygen accepting agent based on 100 parts by mass of the polymer (A). The oxygen accepting agent less than 1 parts by mass might hardly proceed crosslinking, thereby causing insufficient elasticity or undesirable foams. On the other hand, the content above 30 parts by mass happens to result in reduction of rubber properties other than what is described above and deterioration of elasticity.

An inorganic filler used in this invention includes, in concrete terms, calcium carbonate, magnesium carbonate, alumina, aluminum hydroxide, magnesium hydroxide, aluminum silicate (kaolin clay), magnesium silicate (talc), calcium silicate (wollastonite), silicic acid (silica), mica, xonotlite, precipitated barium sulfate and the like. An average particle diameter of these inorganic fillers is 10 μm or less so as to foam homogeneously. The organic fillers may be superficially treated by higher fatty acid, metal salts of fatty acid, ester compounds of fatty acid, silane coupling agent, titanate coupling agent and the like.

A coagent and accelerator used in this invention include, for instance, triallyl cyanurate, triallyl isocyanurate and diallyl phthalate, while a combination thereof with the peroxide preferably increases a degree of crosslinking.

A manner for adding and mixing each component and compounding agent used by this invention is not limited in particular but may be applied a procedure useful for kneading conventional resins and rubber by means of, for instance, open roll, Banbury mixer, pressing kneader, intermixer and extruder.

A rubber composition of this invention may be foamed by either of known foaming methods such as atmospheric foaming, in-mold foaming and applied pressure foaming (press foaming), however, in a desirable foaming method, the rubber composition is extrusion-molded into a predetermined shape, followed by heating and crosslinking. Heating of such a rubber composition may be done by circulating heated air, continuously passing through a hot oven provided with a infrared heater or getting through a molten salt bath or heated glass-beads bath, but it is preferable to heat the extruded rubber composition from inside by means of microwave irradiation, followed by crosslinking and foaming. Further, a plurality of these heating methods may be combined.

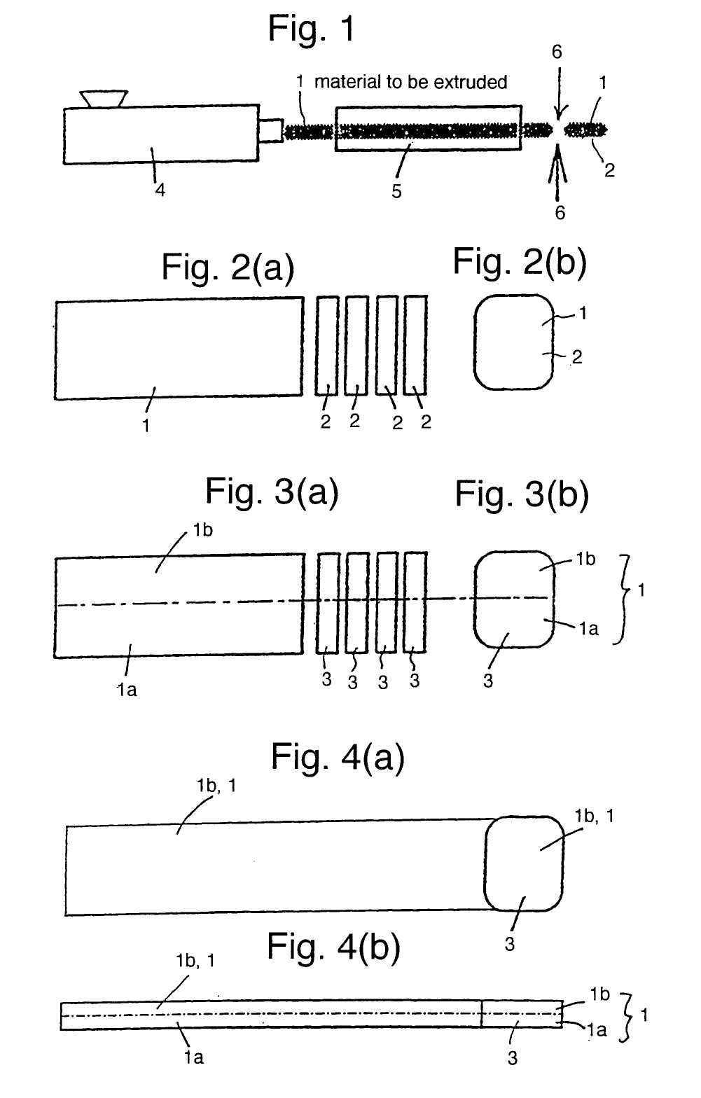

In FIGS. 1 to 4, numerals 4, 5, 6 and 1 designate a continuous extruder, heating and curing oven, cutting or clicking machine and extruded material, respectively, in which plural materials 1a and 1b may also be co-extruded. A single material 1 is extruded as a product 2, while plural materials are co-extruded as a product 3.

### EXAMPLES

This invention will be described in detail by the following examples. It should be understood as a matter of course that this invention is not restricted by these examples.

<Determination of Decomposition Temperature of Blowing Agent>

Decomposition temperature was determined by differential thermal analysis.

Device: Model TG/DTA 220 available from Seiko Instruments Co., Ltd.

Condition: Heating-up at 5° C./min. in a nitrogen atmosphere

<Determination of Chlorine Content in Chlorinated Polyethylene (CPE)>

Chlorine content was determined by Oxygen Flask Combustion Method (JIS K7229).

<Mooney Viscosity Determination>

Mooney viscosity was determined by a method of JIS K6300 (ML₍₁₊₄₎100° C.).

<Polymers>

CPE 1: Chlorinated polyethylene having chlorine content 30% by mass and Mooney viscosity 70 (product of aqueous suspension method; available from SHOWA DENKO Co., Ltd. as a trade name TR31).

CPE 2: Chlorinated polyethylene having chlorine content 20% by mass and Mooney viscosity 60 (product of aqueous suspension method; available from SHOWA DENKO Co., Ltd. as a trade name TR21).

CPE 3: Chlorinated polyethylene having chlorine content 40% by mass and Mooney viscosity 80 (product of aqueous suspension method; available from SHOWA DENKO Co., Ltd. as a trade name TR41).

CPE 4: Chlorinated polyethylene having chlorine content 30% by mass and Mooney viscosity 25 (product of aqueous suspension method; available from SHOWA DENKO Co., Ltd. as a trade name TR32).

CPE 5: Chlorinated polyethylene having chlorine content 30% by mass and Mooney viscosity 120 (product of aqueous suspension method; available from SHOWA DENKO Co., Ltd. as trade name TR33).

EPDM (ethylene-propylene-diene terpolymer): an ethylene-propylene-(5-ethylidene-2-norbornene) terpolymer having Mooney viscosity 40, propylene content 26% by mass and iodine value 20; available from Japan Synthetic Rubber Co., Ltd. as a trade name EP51.

<Organic Blowing Agents>

Blowing agent 1: Azodicarbonamide composite blowing agent having a decomposition temperature of 125° C. (hereinafter referred to as ADCA); available from SANKYO Chemical Co., Ltd. as a trade name Serumaiku CAP.

Blowing agent 2: ADCA composite blowing agent having a decomposition temperature of 150° C.; available from SANKYO Chemical Co., Ltd. as a trade name Serumaiku CAP-500.

Blowing agent 3: ADCA composite blowing agent having a decomposition temperature of 205° C.; available from SANKYO Chemical Co., Ltd. as a trade name Serumaiku C-1.

Blowing agent 4: 4,4′-Oxybis-benzenesulfonyl hydrazide composite blowing agent having a decomposition temperature of 155° C.; available from SANKYO Chemical Co., Ltd. as a trade name Serumaiku S.

<Organic Peroxide (Crosslinking Agent)>

Crosslinking agent 1: Benzoyl peroxide having a one-minute half life temperature of 130° C. (determined in benzene; data from the maker catalog); available from NOF Corporation as a trade name Naipa BW).

Crosslinking agent 2: 1, 1-bis(t-butylperoxy)-3,3,5-trimethylcyclohexane having a one-minute half life temperature of 149° C. (determined in benzene; data from the maker catalog); available from NOF Corporation as a trade name Perhexa 3M).

Crosslinking agent 3: 2,5-dimethyl-2,5-di(t-butylperoxy)hexane having a one-minute half life temperature of 180° C. (determined in benzene; data from the maker catalog); available from NOF Corporation as a trade name Perhexa 25B).

<Other Compounding Agents>

Magnesium oxide: Light magnesium oxide available from Kyowa Chemical Industry Co., Ltd. as a trade name Kyowa Mag 150.

Calcium carbonate: Light calcium carbonate of 0.5 μm in average particle diameter; available from Okutama Kogyou Co., Ltd. as a trade name Tama Pearl TP-222H.

Plasticizer: Diisodesyl phthalate available from New Japan Chemical Co., Ltd. as a trade name Sansosaiza DIDP).

Coagent: Triallyl isocyanurate available from Nippon Kasei Chemical Co., Ltd. as a trade name TAIKU.

Desiccant: Calcium oxide available from Inoue Sekkai Kogyo Co., Ltd. as a trade name Besta BS.

### Example 1 and Comparative Examples 1 and 2

A composition used in Example 1 is shown in Table 1 in parts by mass. The composition was kneaded by means of water-cooled open roll.

TABLE 1

| Starting materials | Parts by mass |
|---|---|
| CPE1 | 100 |
| magnesium oxide | 10 |
| calcium carbonate | 40 |
| plasticizer | 20 |
| blowing agent 1 | 10 |
| crosslinking agent 1 | 2 |
| coagent | 3 |
| desiccant | 5 |
| total | 190 |

The thus kneaded composition was then extruded by means of an extruder, crosslinked and foamed under a condition as shown in Table 2.

TABLE 2

| Item | Condition |
|---|---|
| UHF output | 1.5 kW |
| irradiating time | 3 min. |

Puffs of 40 mm in depth×50 mm in width×7 mm thickness were prepared. Their properties are shown in Table 3. The latex sponge puff and EDPM closed-cell sponge puff were prepared according to a conventional method.

TABLE 3

| | | Comp. | |
|---|---|---|---|
| | Ex. 1 | Ex. 1 | Comp. Ex. 2 |
| item | sponge puff of | latex | EPDM closed-cell |
| | this invention | sponge puff | sponge puff |
| foam structure: | semi-open cell | open cell | closed cell only |
| | (water absorption: | only | |
| | 15%) | | |
| apparent viscosity | 0.15 | 0.1 to 0.2 | 0.1 to 0.2 |
| (g/cm³): | | | |
| 25%-compression | 24 | 5 to 10 | 20 to 25 |
| load (kPa): | | | |
| tensile strength | 390 | 60 to 100 | 300 to 500 |
| (kPa): | | | |
| elongation (%): | 350 | 200 to 300 | 300 to 500 |
| light resistance: | A | B or C | A |
| metal ion resistance: | A | B or C | A |
| makeup properties | A or B | A | B or A |
| and texture: | | | |

In Table 3, A, B and C mean excellent, good and no good, respectively. Light resistance and metal ion resistance were evaluated by color change.

### Examples 1 to 11 and Comparative Example 3

Compositions used in Examples and Comparative Examples are shown in Table 4 in parts by mass. These compositions were kneaded, extruded, crosslinked and foamed in a similar manner as described in Example 1. In Table 4, A, B and C represent resulted states of foaming: homogeneous and excellent foaming, partially heterogeneous foaming and not foaming, respectively.

TABLE 4

| | | | Examples | | | | | | | | | | | Comp. |
|---|---|---|---|---|---|---|---|---|---|---|---|---|---|---|
| | | | 1 | 2 | 3 | 4 | 5 | 6 | 7 | 8 | 9 | 10 | 11 | Ex. 3 |
| Composition | (A) polymer | CPE 1 | 100 | | 50 | 100 | 100 | 100 | | | | 100 | 100 | 20 |
| (parts by wt.) | | CPE 2 | | 100 | | | | | | | | | | |
| | | CPE 3 | | | | | | | 100 | | | | | |
| | | CPE 4 | | | | | | | | 100 | | | | |
| | | CPE 5 | | | | | | | | | 100 | | | |
| | another polymer | EPDM | | | 50 | | | | | | | | | 80 |
| | (B) org. | blowing agent 1 | 10 | 10 | 10 | | | | 10 | 10 | 10 | | | 10 |
| | blowing agent | blowing agent 2 | | | | 10 | 10 | | | | | | 10 | |
| | | blowing agent 3 | | | | | | | | | | 10 | | |
| | | blowing agent 4 | | | | | | 10 | | | | | | |
| | (C) org. | crosslinking agent 1 | 2 | 2 | 2 | 2 | | | 2 | 2 | 2 | | | 2 |
| | peroxide | crosslinking agent 2 | | | | | 2 | 2 | | | | 2 | | |
| | | crosslinking agent 3 | | | | | | | | | | | 2 | |
| | another com. | magnesium oxide | 10 | 10 | 10 | 10 | 10 | 10 | 10 | 10 | 10 | 10 | 10 | 10 |
| | agent | calcium carbonate | 40 | 40 | 40 | 40 | 40 | 40 | 40 | 40 | 40 | 40 | 40 | 40 |
| | | plasticizer | 20 | 20 | 20 | 20 | 20 | 20 | 20 | 20 | 20 | 20 | 20 | 20 |
| | | coagent | 3 | 3 | 3 | 3 | 3 | 3 | 3 | 3 | 3 | 3 | 3 | 3 |
| | | desiccant | 5 | 5 | 5 | 5 | 5 | 5 | 5 | 5 | 5 | 5 | 5 | 5 |

| | | | | | | | | | | | | | |
|---|---|---|---|---|---|---|---|---|---|---|---|---|---|
| foaming | apparent viscosity (g/cm3) | 0.15 | 0.15 | 0.22 | 0.18 | 0.16 | 0.18 | 0.29 | 0.28 | 0.32 | 0.65 | 0.55 | 0.36 |
| properties | foaming state | A | A | A | A | A | A | B | B | B | B | B | C |

This invention makes it possible to modify a basic form without using a number of molds but only with a profile adopter and to co-mold an elaborately designed multi-layer material. Further, it is possible to greatly decrease a material loss and processes of molding, which gives effect of low-cost production. Furthermore, modification of compounding and molding conditions as well as post-handling make it possible to yield products of a variety of foam structures such as closed-cell, semi-open cell and open cell, foam diameters and hardness depending on a makeup powder to be applied. In addition, surface modification, e.g., fusion of a spherical resin having similar properties, can be done by selecting an olefinic elastomer.

What is claimed is:

1. A cellular rubber material prepared by heating a rubber composition comprising
(A) 100 parts by mass of polymer which contains 30 to 100% by mass of polar group-substituted polymer,
(B) 1 to 30 parts by mass of organic blowing agent, and
(C) 0.1 to 10 parts by mass of organic peroxide.

2. A cellular rubber material claimed in claim 1 in which the polar group-substituted polymer contained in the polymer (A) is chlorinated polyethylene.

3. A cellular rubber material claimed in claim 2 in which a chlorine content of the chlorinated polyethylene is 10 to 35% by mass and Mooney viscosity at 100° C. ML₍₁₊₄₎ thereof is 30 to 100.

4. A cellular rubber material claimed in claim 1 in which decomposition temperature T₁ of the organic blowing agent (B) is 100 to 170° C.

5. A cellular rubber material claimed in claim 1 in which one-minute-half life temperature T₂ of the organic peroxide (C) is 100 to 170° C.

6. A cellular rubber material claimed in claim 4 in which a relationship between the decomposition temperature T₁ of organic blowing agent (B) and the one-minute-half life temperature T₂ of organic peroxide (C) is −20° C.≦(T₁−T₂)≦+T30° C.

7. A cellular rubber material prepared by extrusion-molding into a predetermined shape, heating, crosslinking and foaming a rubber composition comprising
(A) 100 parts by mass of polymer which contains 30 to 100% by mass of polar group-substituted polymer,
(B) 1 to 30 parts by mass of organic blowing agent, and
(C) 0.1 to 10 parts by mass of organic peroxide.

8. A cellular rubber material claimed in claim 7 in which the polar group-substituted polymer contained in the polymer (A) is chlorinated polyethylene.

9. A cellular rubber material claimed in claim 8 in which a chlorine content of the chlorinated polyethylene is 10 to 35% by mass and Mooney viscosity at 100° C. ML₍₁₊₄₎ thereof is 30 to 100.

10. A cellular rubber material claimed in claim 7 in which decomposition temperature T₁ of the organic blowing agent (B) is 100 to 170° C.

11. A cellular rubber material claimed in claim 7 in which one-minute-half life temperature T₂ of the organic peroxide (C) is 100 to 170° C.

12. A cellular rubber material claimed in claim 10 in which a relationship between the decomposition temperature T₁ of organic blowing agent (B) and the one-minute-half life temperature T₂ of organic peroxide (C) is −20° C.≦(T₁−T₂)≦+30° C.

13. A cellular rubber material claimed in claim 1 in which heating is conducted by means of microwave irradiation.

14. A method for preparing a cellular rubber material prepared by extrusion-molding into a predetermined shape, heating, crosslinking and foaming a rubber composition comprising (A) 100 parts by mass of polymer which contains 30 to 100% by mass of polar group-substituted polymer, (B) 1 to 30 parts by mass of organic blowing agent, and (C) 0.1 to 10 parts by mass of organic peroxide.

15. A method for preparing a cellular rubber material claimed in claim 14 in which heating is conducted by means of microwave irradiation.
